(19) United States
(12) Patent Application Publication
(10) Pub. No.: US 2017/0171100 A1
(43) Pub. Date: Jun. 15, 2017

(54) Classified Network Bandwidth Management Based on Customer Performance in Social Communities

(71) Applicant: International Business Machines Corporation, Armonk, NY (US)

(72) Inventors: Su Liu, Austin, TX (US); Eric J. Rozner, Austin, TX (US); Chin Ngai Sze, Austin, TX (US); Yaoguang Wei, Austin, TX (US)

(21) Appl. No.: 14/969,542

(22) Filed: Dec. 15, 2015

(51) Int. Cl. H04L 12/911; H04L 29/08

(52) U.S. Cl. CPC H04L 47/70; H04L 67/22

(57) ABSTRACT

An approach is provided that allocates classified network bandwidth based on customer performance in social network communities. In the approach, a network access request from a user. Social media performance data pertaining to the usage of one or more social media websites by the user is received. The user's network priority is then determined based on the received social media performance data. The provider then establishes a network session for the user using the determined network priority, giving the user network access with the provider's network equipment.

### BACKGROUND OF THE INVENTION

Technical Field

This disclosure relates to provide network bandwidth to users based upon such users' performance in online social communities.

Description of Related Art

Individual users' network influence and reputation are increasingly important areas of study and development. An Individual's role and influence on social media can be detected based on existing social network analytics. Quality of Service (QoS) is also an increasingly important topic with regards to network bandwidth. QoS can allow different devices to receive different bandwidth service based on identified network factors. “Follower economy”, “fan economy” and “social network economy” may change business types dramatically. Many social media platforms are providing interfaces, such as APIs, that allow people use social media sign-on as a WiFi login.

### SUMMARY

An approach is provided that allocates classified network bandwidth based on customer performance in social network communities. In the approach, a network access request from a user. Social media performance data pertaining to the usage of one or more social media websites by the user is received. The user's network priority is then determined based on the received social media performance data. The provider then establishes a network session for the user using the determined network priority, giving the user network access with the provider's network equipment.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention will be apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein:

FIG. 1 depicts a block diagram of a processor and components of an information handling system;

FIG. 2 is a network environment that includes various types of information handling systems interconnected via a computer network;

FIG. 3 is a high level diagram depicting components and processes in an exemplary environment that provides classified WiFi bandwidth management based on customer performance in online social communities;

FIG. 4 is a flowchart showing steps performed by a process that monitors users' performance in online social communities; and

FIG. 5 is a flowchart showing steps taken a process that provides preferential user bandwidth based on the user's social media performance scores.

### DETAILED DESCRIPTION

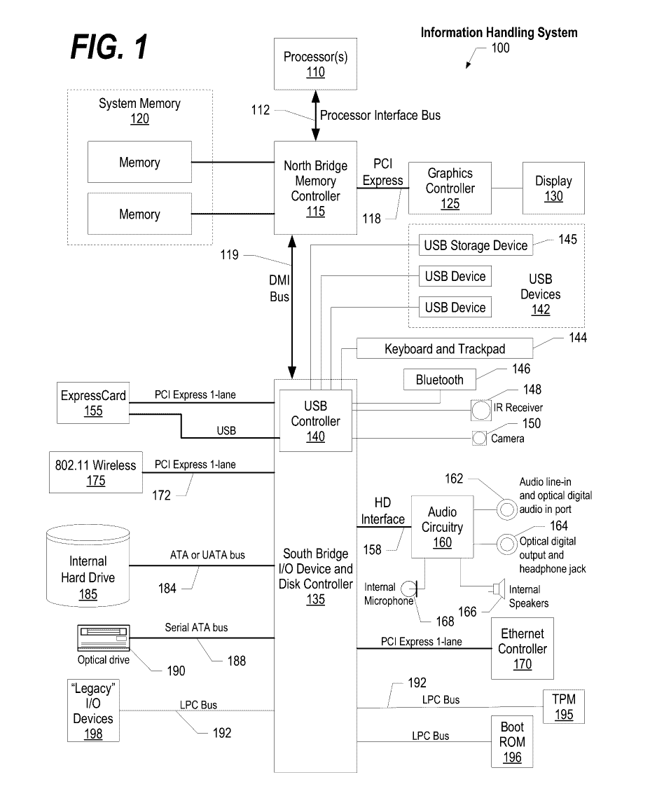

FIGS. 1-5 show an approach for use by businesses that provide network access, usually in the form of a “WiFi hotspot” to users. These businesses encourage user's to use social media to rate and share their shopping experiences on received services from specific locations and stores, and recommend same services or products to other friends and followers. On their reviewer side, reviewers can increase their social score and influence, expend their network, and get more followers because of experience sharing and product/service evaluation. Therefore, the approach provides a way to tie customers social media activities and with network access, such as WiFi access to the Internet. In this approach, classified network bandwidth management method is provided to control network traffic flow so that the appropriate users and groups can receive the proper network resources in the form of network priority established at the provider's network access equipment, such as a router or other network communications adapter.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

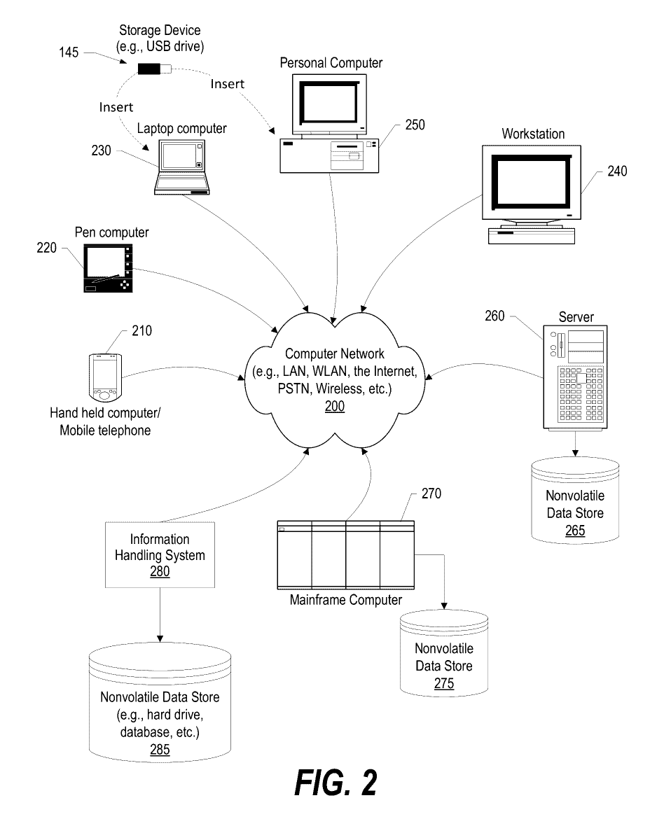

The following detailed description will generally follow the summary of the invention, as set forth above, further explaining and expanding the definitions of the various aspects and embodiments of the invention as necessary. To this end, this detailed description first sets forth a computing environment in FIG. 1 that is suitable to implement the software and/or hardware techniques associated with the invention. A networked environment is illustrated in FIG. 2 as an extension of the basic computing environment, to emphasize that modern computing techniques can be performed across multiple discrete devices.

FIG. 1 illustrates information handling system 100, which is a simplified example of a computer system capable of performing the computing operations described herein. Information handling system 100 includes one or more processors 110 coupled to processor interface bus 112. Processor interface bus 112 connects processors 110 to Northbridge 115, which is also known as the Memory Controller Hub (MCH). Northbridge 115 connects to system memory 120 and provides a means for processor(s) 110 to access the system memory. Graphics controller 125 also connects to Northbridge 115. In one embodiment, PCI Express bus 118 connects Northbridge 115 to graphics controller 125. Graphics controller 125 connects to display device 130, such as a computer monitor.

Northbridge 115 and Southbridge 135 connect to each other using bus 119. In one embodiment, the bus is a Direct Media Interface (DMI) bus that transfers data at high speeds in each direction between Northbridge 115 and Southbridge 135. In another embodiment, a Peripheral Component Interconnect (PCI) bus connects the Northbridge and the Southbridge. Southbridge 135, also known as the I/O Controller Hub (ICH) is a chip that generally implements capabilities that operate at slower speeds than the capabilities provided by the Northbridge. Southbridge 135 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 196 and “legacy” I/O devices (using a “super I/O” chip). The “legacy” I/O devices (198) can include, for example, serial and parallel ports, keyboard, mouse, and/or a floppy disk controller. The LPC bus also connects Southbridge 135 to Trusted Platform Module (TPM) 195. Other components often included in Southbridge 135 include a Direct Memory Access (DMA) controller, a Programmable Interrupt Controller (PIC), and a storage device controller, which connects Southbridge 135 to nonvolatile storage device 185, such as a hard disk drive, using bus 184.

ExpressCard 155 is a slot that connects hot-pluggable devices to the information handling system. ExpressCard 155 supports both PCI Express and USB connectivity as it connects to Southbridge 135 using both the Universal Serial Bus (USB) the PCI Express bus. Southbridge 135 includes USB Controller 140 that provides USB connectivity to devices that connect to the USB. These devices include webcam (camera) 150, infrared (IR) receiver 148, keyboard and trackpad 144, and Bluetooth device 146, which provides for wireless personal area networks (PANs). USB Controller 140 also provides USB connectivity to other miscellaneous USB connected devices 142, such as a mouse, removable nonvolatile storage device 145, modems, network cards, ISDN connectors, fax, printers, USB hubs, and many other types of USB connected devices. While removable nonvolatile storage device 145 is shown as a USB-connected device, removable nonvolatile storage device 145 could be connected using a different interface, such as a Firewire interface, etcetera.

Wireless Local Area Network (LAN) device 175 connects to Southbridge 135 via the PCI or PCI Express bus 172. LAN device 175 typically implements one of the IEEE .802.11 standards of over-the-air modulation techniques that all use the same protocol to wireless communicate between information handling system 100 and another computer system or device. Optical storage device 190 connects to Southbridge 135 using Serial ATA (SATA) bus 188. Serial ATA adapters and devices communicate over a high-speed serial link. The Serial ATA bus also connects Southbridge 135 to other forms of storage devices, such as hard disk drives. Audio circuitry 160, such as a sound card, connects to Southbridge 135 via bus 158. Audio circuitry 160 also provides functionality such as audio line-in and optical digital audio in port 162, optical digital output and headphone jack 164, internal speakers 166, and internal microphone 168. Ethernet controller 170 connects to Southbridge 135 using a bus, such as the PCI or PCI Express bus. Ethernet controller 170 connects information handling system 100 to a computer network, such as a Local Area Network (LAN), the Internet, and other public and private computer networks.

While FIG. 1 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

The Trusted Platform Module (TPM 195) shown in FIG. 1 and described herein to provide security functions is but one example of a hardware security module (HSM). Therefore, the TPM described and claimed herein includes any type of HSM including, but not limited to, hardware security devices that conform to the Trusted Computing Groups (TCG) standard, and entitled “Trusted Platform Module (TPM) Specification Version 1.2.” The TPM is a hardware security subsystem that may be incorporated into any number of information handling systems, such as those outlined in FIG. 2.

FIG. 2 provides an extension of the information handling system environment shown in FIG. 1 to illustrate that the methods described herein can be performed on a wide variety of information handling systems that operate in a networked environment. Types of information handling systems range from small handheld devices, such as handheld computer/mobile telephone 210 to large mainframe systems, such as mainframe computer 270. Examples of handheld computer 210 include personal digital assistants (PDAs), personal entertainment devices, such as MP3 players, portable televisions, and compact disc players. Other examples of information handling systems include pen, or tablet, computer 220, laptop, or notebook, computer 230, workstation 240, personal computer system 250, and server 260. Other types of information handling systems that are not individually shown in FIG. 2 are represented by information handling system 280. As shown, the various information handling systems can be networked together using computer network 200. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 2 depicts separate nonvolatile data stores (server 260 utilizes nonvolatile data store 265, mainframe computer 270 utilizes nonvolatile data store 275, and information handling system 280 utilizes nonvolatile data store 285). The nonvolatile data store can be a component that is external to the various information handling systems or can be internal to one of the information handling systems. In addition, removable nonvolatile storage device 145 can be shared among two or more information handling systems using various techniques, such as connecting the removable nonvolatile storage device 145 to a USB port or other connector of the information handling systems.

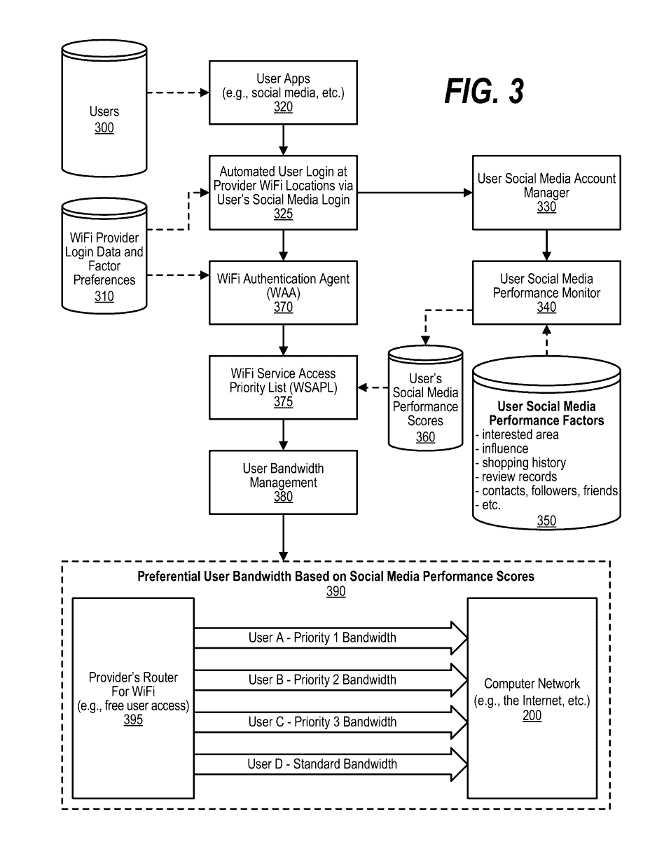

FIG. 3 is a high level diagram depicting components and processes in an exemplary environment that provides classified network bandwidth management based on customer performance in online social communities. At step 320, the process receives a network access request from a user via one or more user applications, such as social media, websites. The user is one of users 300 that is a social media participant with users 300 each being a member of one or more social media communities via one or more social media websites. At step 325, the process receives an automated user login request at the provider's network access point, such as a WiFi request received at one of the provider's routers. As used herein, the provider's “network adapter” refers to any network appliance, such as a router, etc., used to provide access to a network, such as the Internet.

In one embodiment, the request is received via a user's social login. A social login is a form of a single sign-on using existing login information from a social networking service that is used to sign into a third party website, such as the provider's network, in lieu of creating a new login account specifically for the provider's website. The social login is designed to simplify logins for end users as well as provide more and more reliable demographic information to the provider. Social login is often considered a gateway to many of the recent trends in social software and social commerce because it can be used as a mechanism for both authentication and authorization. As such, the social login also allows the provider to receive the user's social media identifier which can be used to receive the user's social media performance factors that are used herein to determine the user's network priority at the provider's network access equipment.

At step 330, the process performs the user social media account manager functions. The user social media account manager is an enhanced program that manage user accounts and is capable of managing at least one social media account. At step 340, the process performs the user social media performance monitor function. The user social media performance monitor includes a set of modules and Application Programming Interfaces (APIs) to determine the user's social media performance factors. These factors determine whether the user is an active reviewer and stronger influencer in a promoted area (e.g., food, art, fashion etc.). For instance, if a particular user wrote extensive restaurant reviews with more then a certain number on social media websites, then, if the network access provider being accessed is a restaurant, the provider may want to give the user a higher network priority. Note that data pertaining to users' interested areas, shopping histories, reviewing histories, numbers of followers, etc. can be included in user social media performance factors 350. The result of the user social media performance monitor is one or more user social media performance scores that are shown stored in data store 360.

At step 370, the provider performs the WiFi Authentication Agent (WAA) function. WiFi authentication agent is an enhanced program for handling automated social media application login. In order to support the social media influence feature, extra parameters and enhanced data structures are included. For instance, special promotion area and related user influence data can be processed either during the authentication process or in parallel with this process. Function 370 receives the provider's login data and social media factor preferences from data store 310. The social media factor preferences describe the social media attributes that are preferred by this provider. For example, a provider that is a restaurant might have a preference for users that have ample restaurant reviews so a user with many restaurant reviews might receive a higher network priority than a user that has many fashion reviews but few if any food reviews.

At step 375, the process performs the WiFi Service Access Priority List (WSAPL) function. This function creates a priority accessing list according to the user's social media influence for network priority (e.g., Quality of Service (QoS), etc.). The list can be dynamically updated for adding new users and remove old users. At step 380, the process performs the user bandwidth management function. This function assigns users to different bandwidth channels (priorities) based on the WSAPL that was created in step 375. User Bandwidth Based on Social Media Performance Scores 390 shows provider's network access equipment 395 being used to provide different network priority levels to different users accessing the network, such as the Internet, through the provider's equipment.

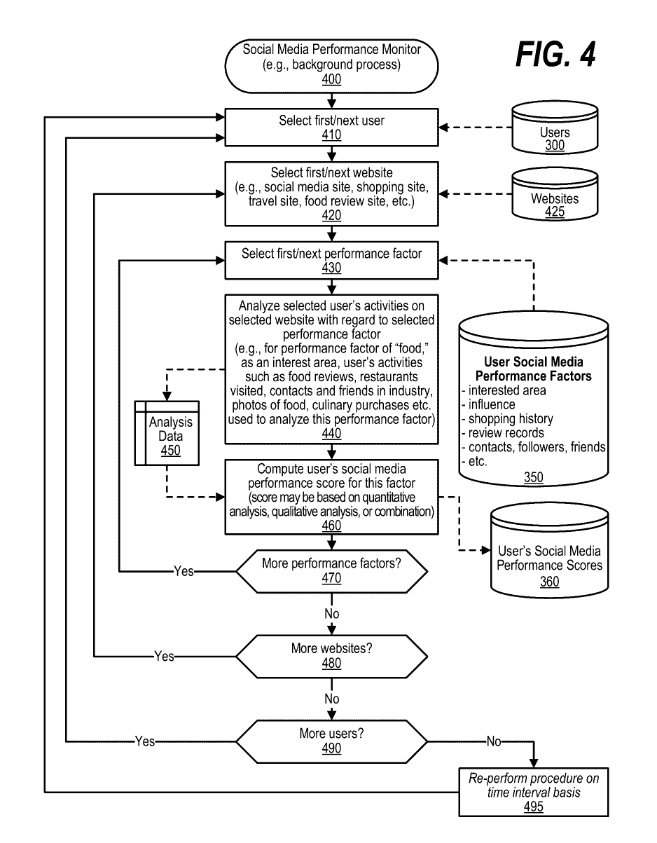

FIG. 4 is a flowchart showing steps performed by a process that monitors users' performance in online social communities. FIG. 4 processing commences at 400 and shows the steps taken by a process that performs the social media performance monitor process. This process can be performed as a background process so that the social media performance factor data is available when a user requests network access at the provider. At step 410, the process selects the first user from the set of social media users 300. At step 420, the process selects the first website (e.g., social media site, shopping site, travel site, food review site, etc.) used by the selected user. The website data is retrieved from data store 425.

At step 430, the process selects the first performance factor for analysis. The performance factors are retrieved from data store 350 and can include factors such as the user's interested areas, areas of influence, shopping history, review records and history, contacts, followers, friends, and the like. At step 440, the process analyzes selected user's activities on selected website with regard to the selected performance factor. For example, for a performance factor of “food,” as an interest area, the user's activities such as food reviews, restaurants visited, contacts and friends in the food industry, photos of food, culinary purchases etc. would be used to analyze this performance factor. The results of the analysis are stored in memory area 450.

At step 460, the process computes the user's social media performance score for the selected factor based on the analysis data stored in memory area 450. The social media performance score may be based on a quantitative analysis of the data, a qualitative analysis of the data, or combination that uses both qualitative analysis and quantitative analysis to compute the score. The user's social media performance scores are stored in data store 360.

The process determines as to whether there are more social media performance factors to select and process (decision 470). If there are more social media performance factors to select and process, then decision 470 branches to the ‘yes’ branch which loops back to step 430 to select and process the next social media performance factor as described above. This looping continues until there are no more social media performance factors to process, at which point decision 470 branches to the ‘no’ branch exiting the loop.

The process determines as to whether there are more websites, such as social media websites, to select and process (decision 480). If there are more websites to select and process, then decision 480 branches to the ‘yes’ branch which loops back to step 420 to select and process the next website as described above. This looping continues until there are no more websites to process, at which point decision 480 branches to the ‘no’ branch exiting the loop.

The process determines as to whether there are more users in the social media community to select and process from data store 300 (decision 490). If there are more users to process, then decision 490 branches to the ‘yes’ branch which loops back to step 410 to select the next user from data store 300 and process the user's social media performance as described above. This looping continues until there are no more users to process, at which point decision 490 branches to the ‘no’ branch exiting the loop. At step 495, the process re-performs procedure on time interval basis (e.g., every day, etc.).

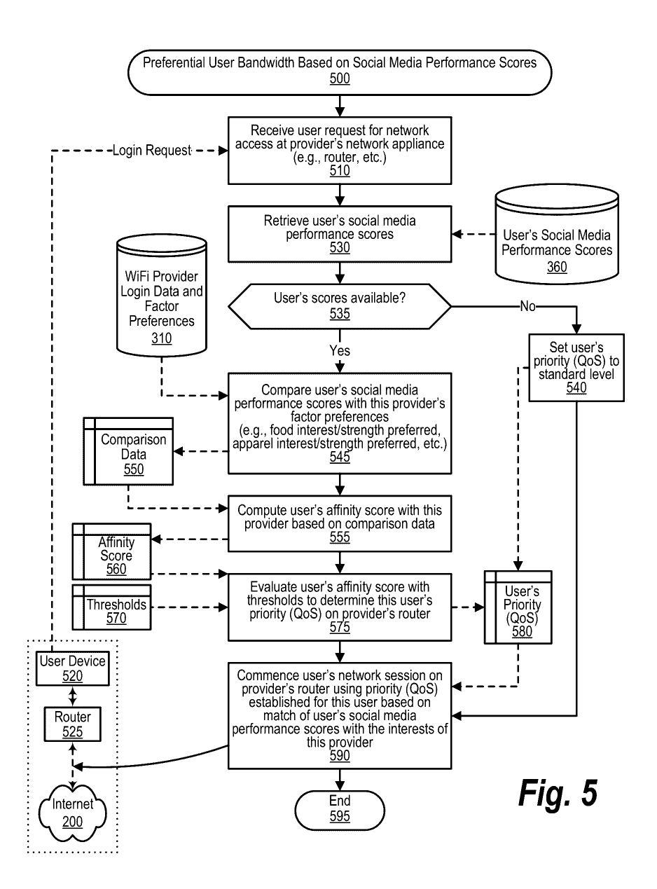

FIG. 5 is a flowchart showing steps taken a process that provides preferential user bandwidth based on the user's social media performance scores. FIG. 5 processing commences at 500 and shows the steps taken by a process that provides preferential user network bandwidth based on the user's social media performance scores. At step 510, the process receives a user's request for network access at provider's network appliance (e.g., router, etc.). At step 530, the process retrieves user's social media performance scores from data store 360. The user's social media performance scores were calculated using the process shown in FIG. 4. The process determines as to whether social media performance scores are available for this user (decision 535). If social media performance scores are available for this user, then decision 535 branches to the ‘yes’ branch to perform steps 545 through 575. On the other hand, if social media performance scores are not available for this user, then decision 535 branches to the ‘no’ branch to perform step 540 whereupon the process sets the user's network priority (e.g., QoS, etc.) to a standard, or default, priority level. This standard priority level is stored in memory area 580.

Steps 545 through 575 are performed when a user's social media performance scores are available. At step 545, the process compares the user's social media performance scores with this provider's social media factor preferences. For example, a provider that is a restaurant may provide higher priority levels to user's with high social media performance scores in food related areas, whereas a department store may provide higher priority levels to user's with higher product review scores. The comparison data is stored in memory area 550.

At step 555, the process computes the user's affinity score with this provider based on the comparison data that was stored in memory area 550. For example, a ten point scale could be used in the computation so that users with an extremely strong affinity with the provider receive a “ten” and users with little or no affinity with the provider receive a “one.” The computed affinity score is stored in memory area 560.

At step 575, the process evaluates the user's affinity score stored in memory area 560 with thresholds retrieved from memory area 570 to determine this user's network priority (e.g., QoS, etc.) on the provider's network appliance, such as a router. The user's priority, or QoS, is stored in memory area 580.

At step 590, the process commences user's network session on the provider's network access equipment (e.g., router, etc.) using the network priority established for this user and stored in memory area 580. The user's network priority is based on how well the user's social media performance scores match with the social media performance factors of interest to this provider. As shown, the user's device 520 accesses the provider's network appliance 525, such as a WiFi enabled router. The user's network session between network appliance 525 and network 200 is established with the priority that was determined by the provider for this user. In this manner, users with stronger affinities with the provider, as evidenced by the users' social media performance scores, receive more priority (e.g., higher bandwidth, etc.) from the provider's network appliance to the network than those users with weaker affinities with the provider. FIG. 5 processing thereafter ends at 595.

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A method implemented by an information handling system that includes one or more processors, a memory accessible by at least one of the processors, and a network adapter accessible by at least one of the processors, the method comprising:
retrieving a network access request from a user;
receiving a social media performance data pertaining to usage of one or more social media websites by the user;
determining a network priority pertaining to the user based on the received social media performance data; and
establishing, over the network adapter, a network session using the determined network priority, wherein the network session provides the user with the requested network access.

2. The method of claim 1 further comprising:
receiving a social login pertaining to the user prior to receiving the social media performance data pertaining to the user.

3. The method of claim 1 wherein the social media performance data includes a plurality of social media performance values that pertain to the user, wherein one or more of the social media performance values corresponding to one or more different areas of influence of the user on the one or more social media websites, and wherein the method further comprises:
comparing the social media performance values with a set of provider preferences, wherein the provider preferences pertain to a provider of the network access.

4. The method of claim 3 further comprising:
computing an affinity score based on the comparison, wherein the determined network priority is based on the computed affinity score.

5. The method of claim 4 further comprising:
comparing the computed affinity score with one or more thresholds established by the provider, wherein the network priority further establishes a quality of service (QoS) that is used for the established network session.

6. The method of claim 4 further comprising:
weighting the social media performance values pertaining to the different areas of influence that align with the provider's preferences higher than the social media performance values pertaining to the different areas of influence that fail to align with the provider's preferences, wherein the affinity score is computed using the weighted values.

7. The method of claim 3 wherein at least one of the areas of influence are selected from the group consisting of an interest area of the user, an activity of the user, one or more businesses visited by the user, one or more reviews by the user, one or more contacts of the user in an industry area, one or more media content of the user, one or more comments of the user, and one or more purchase of the user.

8. An information handling system comprising:
one or more processors;
a memory coupled to at least one of the processors;
a network adapter accessible by at least one of the processors; and
a set of computer program instructions stored in the memory and executed by at least one of the processors in order to perform actions comprising:
retrieving, at the network adapter, a network access request from a user;
receiving a social media performance data pertaining to usage of one or more social media websites by the user;
determining a network priority pertaining to the user based on the received social media performance data; and
establishing, over the network adapter, a network session using the determined network priority, wherein the network session provides the user with the requested network access.

9. The information handling system of claim 8 wherein the actions further comprise:
receiving a social login pertaining to the user prior to receiving the social media performance data pertaining to the user.

10. The information handling system of claim 8 wherein the social media performance data includes a plurality of social media performance values that pertain to the user, wherein one or more of the social media performance values corresponding to one or more different areas of influence of the user on the one or more social media websites, and wherein the information handling system further comprises:
comparing the social media performance values with a set of provider preferences, wherein the provider preferences pertain to a provider of the

11. The information handling system of claim 10 wherein the actions further comprise:
computing an affinity score based on the comparison, wherein the determined network priority is based on the computed affinity score.

12. The information handling system of claim 11 wherein the actions further comprise:
comparing the computed affinity score with one or more thresholds established by the provider, wherein the network priority further establishes a quality of service (QoS) that is used for the established network session.

13. The information handling system of claim 11 wherein the actions further comprise:
weighting the social media performance values pertaining to the different areas of influence that align with the provider's preferences higher than the social media performance values pertaining to the different areas of influence that fail to align with the provider's preferences, wherein the affinity score is computed using the weighted values.

14. The information handling system of claim 11 wherein at least one of the areas of influence are selected from the group consisting of an interest area of the user, an activity of the user, one or more businesses visited by the user, one or more reviews by the user, one or more contacts of the user in an industry area, one or more media content of the user, one or

15. A computer program product stored in a computer readable storage medium, comprising computer program code that, when executed by an information handling system, performs actions comprising:
retrieving a network access request from a user;
receiving a social media performance data pertaining to usage of one or more social media websites by the user;
determining a network priority pertaining to the user based on the received social media performance data; and
establishing a network session using the determined network priority, wherein the network session provides the user with the requested network access.

16. The computer program product of claim 15 wherein the actions further comprise:
receiving a social login pertaining to the user prior to receiving the social media performance data pertaining to the user.

17. The computer program product of claim 15 wherein the social media performance data includes a plurality of social media performance values that pertain to the user, wherein one or more of the social media performance values corresponding to one or more different areas of influence of the user on the one or more social media websites, and wherein the computer program product further comprises:
comparing the social media performance values with a set of provider preferences, wherein the provider preferences pertain to a provider of the network access.

18. The computer program product of claim 17 wherein the actions further comprise:
computing an affinity score based on the comparison, wherein the determined network priority is based on the computed affinity score.

19. The computer program product of claim 18 wherein the actions further comprise:
comparing the computed affinity score with one or more thresholds established by the provider, wherein the network priority further establishes a quality of service (QoS) that is used for the established network session.

20. The computer program product of claim 18 wherein the actions further comprise:
weighting the social media performance values pertaining to the different areas of influence that align with the provider's preferences higher than the social media performance values pertaining to the different areas of influence that fail to align with the provider's preferences, wherein the affinity score is computed using the weighted values.
